(19) United States
(12) Patent Application Publication
(10) Pub. No.: US 2013/0250561 A1
(43) Pub. Date: Sep. 26, 2013

(54) Solar and Fuel Powered Portable Light Tower

(71) Applicant: Jeremy Walter Knodel, Chandler, AZ (US)

(72) Inventor: Jeremy Walter Knodel, Chandler, AZ (US)

(21) Appl. No.: 13/429,245

(22) Filed: Mar. 23, 2012

(51) Int. Cl. F21L 4/02; F21L 4/00

(52) U.S. Cl. 362/184; 362/190

(57) ABSTRACT

A solar and fuel powered portable light tower comprises a portable base, a light panel arm, a first power source, a second power source, and a control panel. The light panel arm is connected to the portable base and the first and second power source are positioned within the portable base. The control panel, which is positioned within the portable base, controls the solar and fuel powered portable light tower. The light panel arm comprises a plurality of light panels. The plurality of light panels is powered by either the first power source or the second power source. The second power source also acts as an onsite generator. An insulated wall separates the first power source and the second power source. A plurality of photovoltaic panels acts as the first power source and a fuel powered generator acts the second power source.

### FIELD OF THE INVENTION

The invention relates generally to an apparatus that provides light to a large area, more specifically, through allowance of utilizing energy from either a solar powered source or a fuel powered source which have been combined into a single device.

### BACKGROUND OF THE INVENTION

Most large scaled operations such as, construction, public events, and emergency situations require many different components and devices to complete an assigned task. Portable light towers are one of the components required during those assigned situations. Traditional portable light towers are mainly powered from fuel powered generators. The present invention relates to the portable light tower where the portable light tower offers a combination unit of a primary solar powered source and a fuel powered source as the contingent backup plan. Both power sources are combined within a single unit/frame. In addition to acting as the backup power source in the event that the solar battery supply were to run out during operations or were to be unavailable for charging (due to cloudy, rainy day, etc), the combination unit can allow for light panels to be powered by the solar powered source while the fuel powered source provides an onsite generator for use. Using the solar powered source as its primary source of power, the present invention can provide added benefits within the latest push towards the use of renewable resources within the commercial construction industry without compromising any functionality. Many new construction projects are setting goals for LEED (leadership in energy and environmental design) Certification. In order to achieve LEED Certification, the utilization of building equipment needs to become more increasingly involved with the idea of healthy working environment. This is the primary objective that has led to the creation of the present invention. The present invention provides a drastic reduction in noise levels, while allowing the use of light panels during night shifts. The present invention also allows for increased use of renewable resources, such as solar energy, as well as providing a reduced fuel consumption costs and an available option for dual uses such as a simultaneous operational of the light panels and the onsite generator.

### BRIEF DESCRIPTION OF THE DRAWINGS

FIG. 1 is a perspective view of the present invention.

FIG. 2 is a right view of the present invention.

FIG. 3 is a left view of the present invention.

FIG. 4 is a back view of the present invention.

FIG. 5 is a left view of the present invention showing the light tower in a down (transit) position.

FIG. 6 is a back view of the present invention.

FIG. 7 is a cross section view of the FIG. 6. Showing the inside components of the primary and secondary power source.

FIG. 8 is a system diagram of the electrical connection between the primary power source, the secondary power source, the light tower, and the control panel.

### DETAIL DESCRIPTIONS OF THE INVENTION

All illustrations of the drawings are for the purpose of describing selected versions of the present invention and are not intended to limit the scope of the present invention.

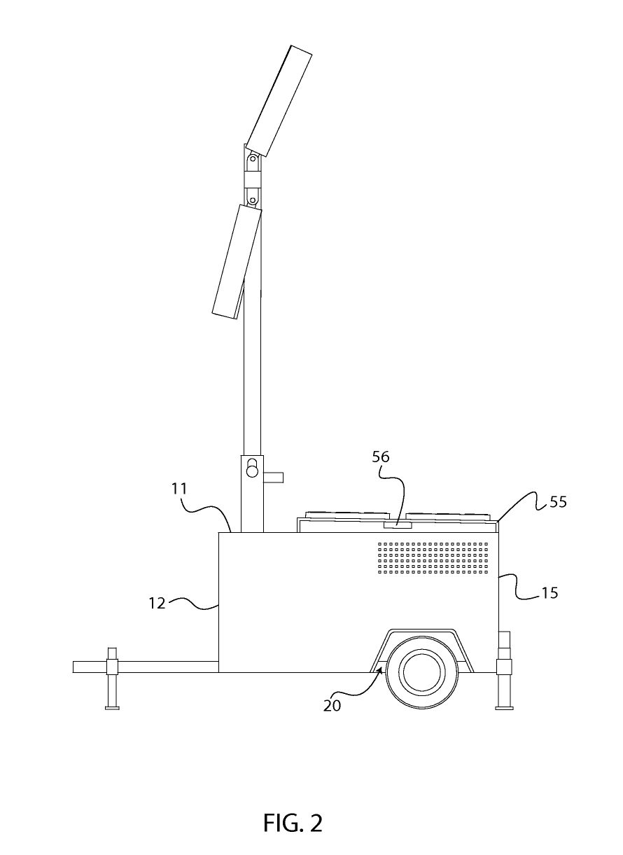

The present invention is a solar and fuel powered light tower that comprises a portable base 1, a light panel arm 3, a first power source 5, a second power source 7, and a control panel 9. In reference to FIG. 2 and FIG. 7, the portable base 1 comprises a top surface 11, a first surface 12, a second surface 15, an insulated wall 17, a first enclosure 18, a second enclosure 19, and a bottom surface 20. The top surface 11 is perpendicularly connected to the first surface 12 and the second surface 15 from top. The bottom surface 20 is perpendicularly connected to the first surface 12 and the second surface 15 and positioned oppositely from the top surface 11. The bottom surface 20 comprises an axle 21 and a pair of wheels 22. The axle 21 is connected to the bottom surface 20 and the pair of wheels 22 is connected to the axle 21. The axle 21 and the pair of wheels 22 assist the present invention to transport from one location to another. The top surface 11, the first surface 12, and the second surface 15 are made by high strength and light weighted material such as, aluminum. The material has to withstand the elevated heat created by the present invention. The insulated wall 17 is centrally positioned between the first surface 12 and the second surface 15. The insulated wall 17 is equipped with fire resistant materials to improve the factor of safety in the present invention. The first enclosure 18 is positioned between the first surface 12 and the insulated wall 17 and the second enclosure 19 is positioned between the second surface 15 and the insulated wall 17. The first power source 5 is positioned inside the first enclosure 18 and the second power source 7 is positioned inside the second enclosure 19. The insulated wall 17 acts as a protective barrier between the first power source 5 and the second power source 7 separating the both power sources which reduce any kind of fire hazards within the present invention.

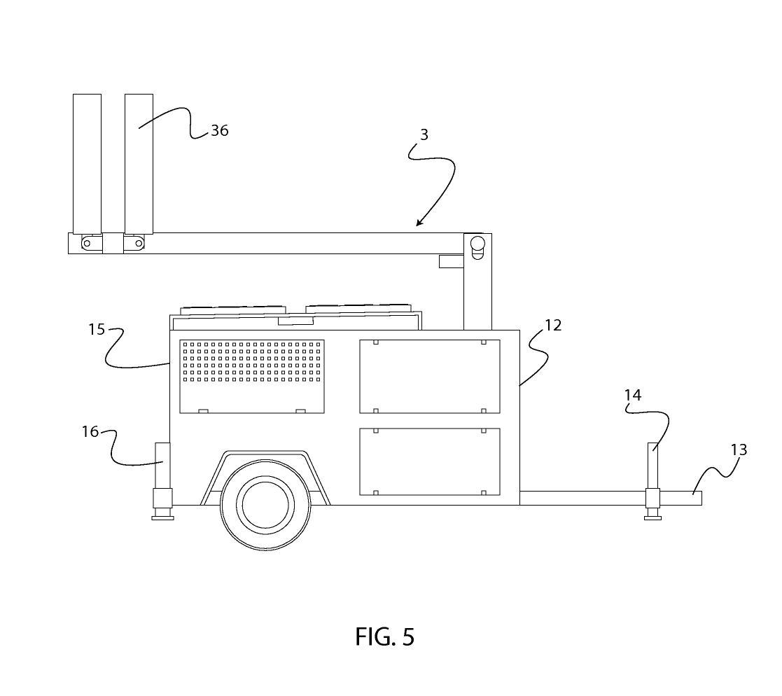

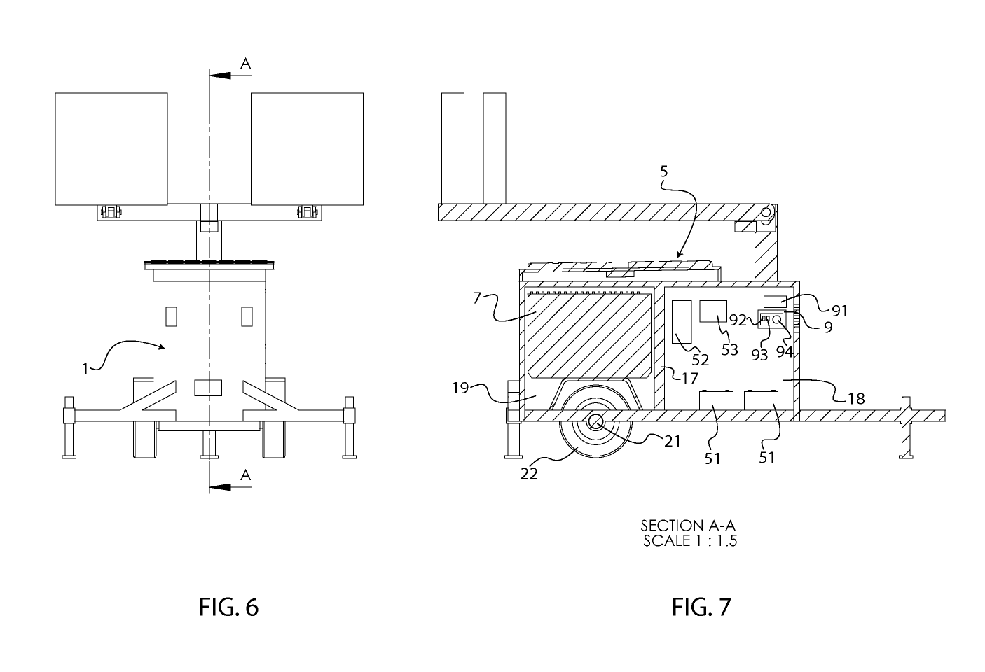

In reference to FIG. 5, the first surface 12 comprises a hitch connector 13 and a connector jack 14. The hitch connector 13 is centrally positioned outside from the first surface 12. The hitch connector 13 is connected to the first surface 12 from below and extended out from the first surface 12. The connector jack 14 is connected to the hitch connector 13 away from the first surface 12. The hitch connector 13 is hooked to another vehicle during transportation so the present invention can be easily transported. Since the present invention only has one set of wheels, the present invention requires the connector jack 14. The connector jack 14 supports the frontend of the present invention. The connector jack 14 extends toward the ground surface so the portable base 1 can be stationed parallel to the ground surface. During transportation, the connector jack 14 is pulled back toward the hitch connector 13 so the connector jack 14 does not make contact with the ground surface. The present is also comprises a license plate, brake lights and signal lights making the present invention street legal for transporting purposes.

The second surface 15 comprises a pair of supporting jacks 16. The pair of supporting jacks 16 is connected to the second surface 15 and positioned outside of the second surface 15. The pair of supporting jacks 16 supports the backend of the present invention. The backend weight of the portable base 1 is evenly distributed to the pair of supporting jacks 16 so the present invention can be stationed parallel to the ground surface. During transportation, the pair of supporting jacks 16 is pulled upward so the pair of jacks does not make contact with the ground surface.

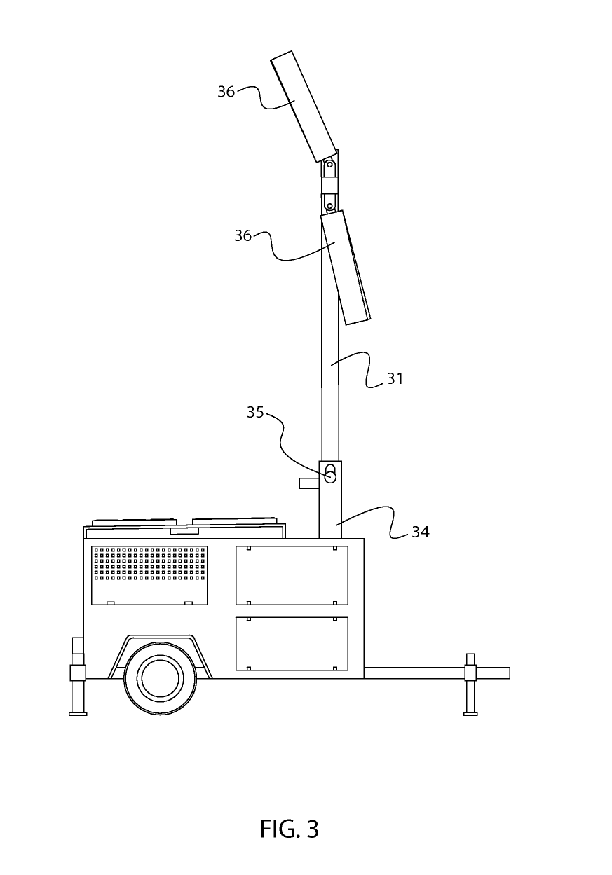

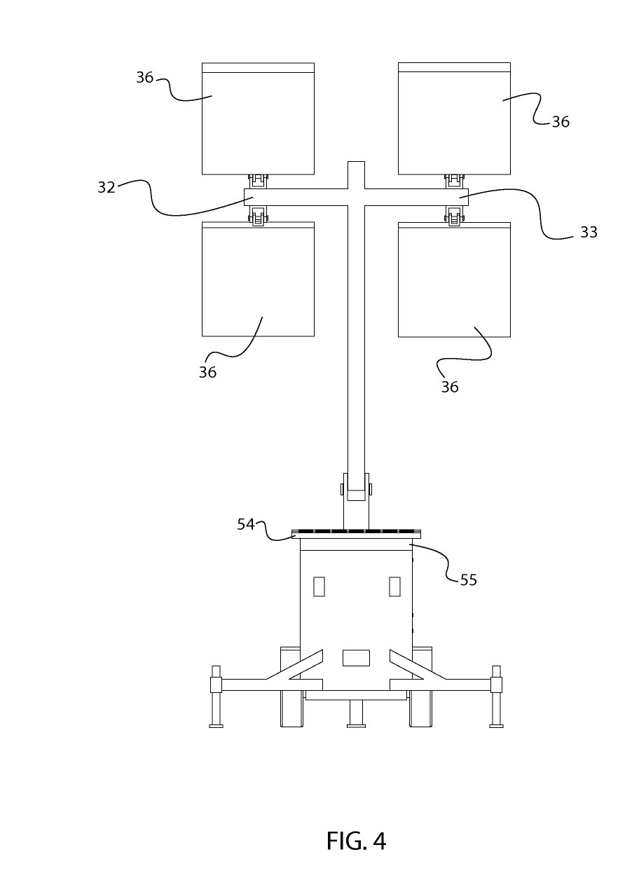

In reference to FIG. 3 and FIG. 4, the light panel arm 3 is positioned on the top surface 11 between a plurality of photovoltaic panels 54 and the first surface 12. The light panel arm 3 comprises a telescopic arm 31, a vertical arm 34, a connecting pin 35, and a plurality of light panels 36. The vertical arm 34 is connected to the telescopic arm 31 with a connecting pin 35. The vertical arm 34 is also connected to the top surface 11 from the free end so the telescopic arm 31 pivots from zero degrees to ninety degrees around the connecting pin 35. The telescopic arm 31 can be positioned into an up position and a down position where the up position is perpendicular to the top surface 11 and the down position is parallel to the top surface 11. The telescopic arm 31 is pivoted into the down position during transportation so the telescopic arm 31 and its components are protected. The telescopic arm 31 comprises a first extension arm 32 and a second extension arm 33. The first extension arm 32 and the second extension arm 33 extend out from the telescopic arm 31. The plurality of light panels 36 is adjacently positioned on the first extension arm 32 and the second extension arm 33. The plurality of light panels 36 can be tilted up and down so the plurality of light panels 36 is able to aim a given location. The plurality of light panels 36 is tilted away from the top surface 11 during transportation so the plurality of light panels 36 is protected. The plurality of light panels 36 is made of many LED lights for superior functionality. The plurality of light panels 36 is connected to the control panel 9 by an insulated conduit line. When the plurality of light panels 36 is operated, the telescopic arm 31 is positioned in the up position.

In reference to FIG. 7, the control panel 9 is positioned within the portable base 1 and the control panel 9 controls all of the functionality in the present invention. The control panel 9 comprises a junction box 91, a first switch, a second switch 93, and a battery monitoring unit 94. The first switch, the second switch 93, and the battery monitoring unit 94 are positioned on the control panel 9 and only the junction box 91 is positioned next to the control panel 9. The first switch 92 and the second switch 93 are electrically connected to the junction box 91. The first switch 92 is assigned to control the first power source 5 and the second switch 93 is assigned to control the second power source 7. The insulated conduit line which connects the plurality of light panels 36 and the control panel 9 can be further described as follow; the insulated conduit line electrically connects the plurality of light panels 36 and the junction box 91. The battery monitoring unit 94 is electrically connected to the first power source 5.

Power distribution of the present invention is accomplished by the first power source 5 and the second power source 7. All the electrical connections in the first power source 5 and the second power source 7 are finished with the insulated conduit lines. The first power source 5 and the second power source 7 are electrically connected to the control panel 9. The first power source 5 is considered as the primary power source of the present invention. The second power source 7 acts either as a backup power source of the present invention or it can use as a standalone generator.

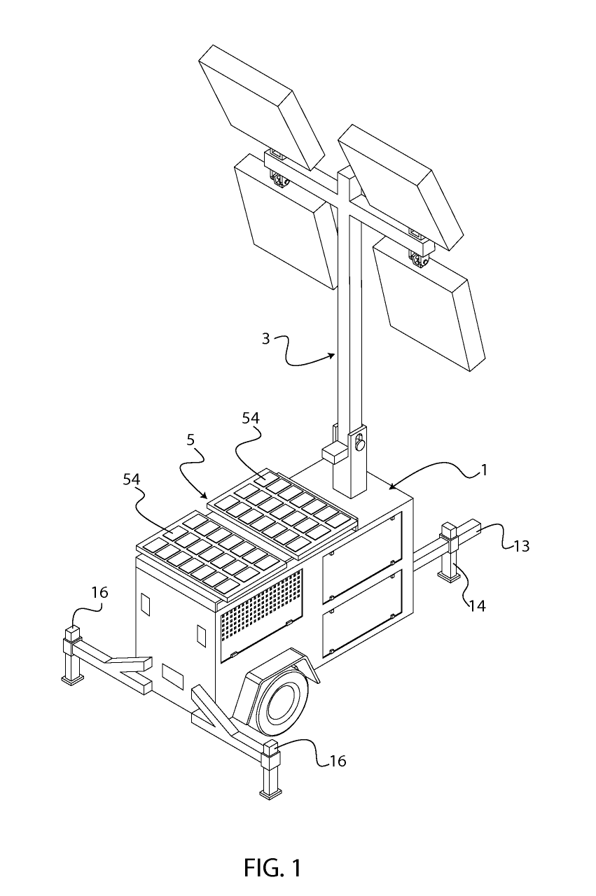

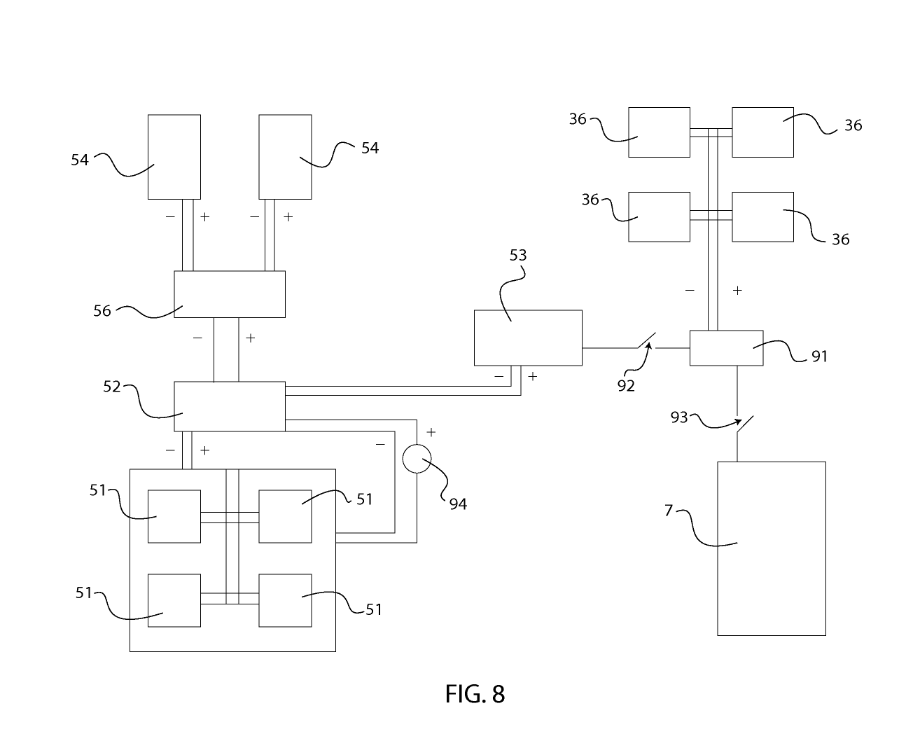

In reference to FIG. 1, FIG. 7, and FIG. 8, the first power source 5 comprises a plurality of batteries 51, a charge controller 52, an inverter box 53, the plurality of photovoltaic panels 54, and a combiner box 56. The plurality of photovoltaic panels 54 comprises a connecting frame 55. The plurality of photovoltaic panels 54 is connected to the connecting frame 55 and the connecting frame 55 is attached to the top surface 11. The plurality of photovoltaic panels 54 is positioned in line on the connecting frame 55 and mounted with a 1% slope from front to back. The plurality of photovoltaic panels 54 can also be mounted side by side. However, side by side mounting results in the plurality of photovoltaic panels 54 to further overhang from the top surface 11. If the plurality of photovoltaic panels 54 overhangs from sides, it is recommended that the portable base 1 width be enlarged for protection purposes. Each of the photovoltaic panels 54 should be at least 280 watts. The combiner box 56 is connected to the connecting frame 55 and the plurality of photovoltaic panels 54 is electrically connected to the combiner box 56. The combiner box 56 is an electrical component which combines multiple sets of wires from the plurality of photovoltaic panels 54 into a single set of wires (positive, negative, and ground). The combiner box 56 is made of sheet metal or fiberglass. The single set of wires from the combiner box 56 is then electrically connected to the charge controller 52 where the charge controller 52 is positioned above the plurality of batteries 51 and connected to the portable base 1. The plurality of photovoltaic panels 54 absorbs solar radiation and the solar radiation is transferred through the combiner box 56 and then to the charge controller 52. The plurality of batteries 51 is also electrically connected with the charge controller 52. The charge controller 52 is electrically connected with the battery monitoring unit 94. The battery monitoring unit 94 can be a built-in or an attached system that monitors the energy level of the plurality of batteries 51. The plurality of batteries 51 are positioned inside the first enclosure 18 and connected to the bottom surface 20. The charge controller 52 limits the rate at which electric current is drawn from the plurality of batteries 51 and prevents the plurality of batteries 51 from overcharging. At least four gel cell batteries are used in the plurality of batteries 51 for proper storage of the electric current energy. The energy from the charge controller 52 charges the plurality of batteries 51 creating energy. Then the charge controller 52 extracts the energy out from the plurality of batteries 51 and re-routed to the inverter box 53. The charge controller 52 is electrically connected with the inverter box 53 where the inverter box 53 is positioned above the plurality of batteries 51 and connected to the portable base 1. The inverter box 53 converts the low voltage direct current from the plurality of batteries 51 into 120 volt alternating current so the plurality of light panels 36 can be powered. The first power source 5 is completed when inverter box 53 electrically connects with the first switch.

In reference to FIG. 7 and FIG. 8, the second power source 7 is a fuel powered generator. The fuel powered generator can be powered by gasoline, diesel, propane, or clean diesel. Since propane and clean diesel maintain maximum clean energy efficiency, they are the recommendation as the fuel resources for the fuel powered generator. The second power source 7 is electrically connected to the second switch 93. The fuel powered generator functions similarly to traditional generators and is controlled using the control panel 9.

The present invention can be used in night construction situations, events, utility works, emergency situations, or any kind of general nighttime operation. An operator can easily control the present invention through the control panel 9. Since the plurality of photovoltaic panels 54 charges the plurality of batteries 51 during the daytime, the plurality of light panels 36 can be turned on during nighttime. The first switch 92 turns on and off the plurality of light panels 36. Since the first switch 92 is connected to the first power source 5, the plurality of light panels 36 is operated through the plurality of batteries 51. The battery monitoring unit 94 displays the energy level of the plurality of batteries 51. The present invention can also be powered from the second power source 7 when the first power source 5 is not available. For example, if the plurality of batteries 51 drains during operation, the operator can turn off the first switch 92 and turn on the second switch 93. Then the second power source 7 is able to power the plurality of lights. In another situation: the plurality of batteries 51 may not be charged on a cloudy day due to the lack of solar radiation. Since there is not enough power created by the first power source 5, the present invention can be powered from the second power source 7. The second power source 7 can also be utilized to power other equipment such as, drills and saws while the plurality of lights is powered by the first power source 5. The simultaneous operation of the plurality of lights and the standalone generator improves the efficiency of the present invention compared to traditional light towers.

Since the first power source 5 drastically reduces the air and noise pollution, the present invention is an earth and human, friendly device which could gain LEED (leadership in energy and environmental design) points from the U.S. Green Building Council as it may create a healthy working environment. The present invention is also an efficient solution for the rising fuel cost because of the low fuel consumption of the present invention compared to traditional light towers. When the present invention is powered from the first power source 5, noise level is drastically reduced compared to the traditional light towers. Because of the reduced noise level in the present invention, the present invention can be used in locations such as, residential areas, active hospitals, occupied hotels, concerts, and many other places where the noise levels need to be maintained at lower levels.

Although the invention has been explained in relation to its preferred embodiment, it is to be understood that many other possible modifications and variations can be made without departing from the spirit and scope of the invention as hereinafter claimed.

What is claimed is:

1. A solar and fuel powered portable light tower comprises,
a portable base;
a light panel arm;
a first power source;
a second power source;
a control panel;
the portable base comprises a top surface, a first surface, a second surface, an insulated wall, a first enclosure, a second enclosure, and a bottom surface;
the light panel arm being positioned on the top surface;
the first power source being positioned inside the first enclosure;
the second power source being positioned inside the second enclosure; and
the control panel comprises a junction box, a first switch, a second switch, and a battery monitoring unit.

2. The solar and fuel powered portable light tower as claimed in claim 1 comprises,
the top surface being perpendicularly connected to the first surface and the second surface;
the bottom surface being perpendicularly connected to the first surface and the second surface and positioned oppositely from the top surface;
the insulated wall being centrally positioned between the first surface and the second surface within the top surface and the bottom surface;
the first enclosure being positioned between the first surface and the insulated wall; and
the second enclosure being positioned between the second surface and the insulated wall.

3. The solar and fuel powered portable light tower as claimed in claim 2 comprises,
the first surface comprises a hitch connector and a connector jack;
the hitch connector being centrally connected onto the first surface from below;
the connector jack being connected to the hitch connector;
the second surface comprises a pair of supporting jacks; and
the pair of jacks being positioned oppositely from each other and connected onto the second surface from below.

4. The solar and fuel powered portable light tower as claimed in claim 2 comprises,
the bottom surface comprises a pair of wheels and an axle;
the axle being traversed through the bottom surface; and
the pair of wheels being connected to the axle from each end.

5. The solar and fuel powered portable light tower as claimed in claim 1 comprises,
the light panel arm comprises a telescopic arm, a vertical arm, a connecting pin, and a plurality of light panels;
the telescopic arm comprises a first extension arm and a second extension arm;
the vertical arm being positioned between the telescopic arm and the top surface and connected to the top surface;
the first extension arm and the second extension arm being horizontally extended out from the telescopic arm;
the telescopic arm being connected to the vertical arm by the connecting pin;
the plurality of light panels being adjacently positioned on the first extended arms and the second extension arm; and
the plurality of light panels being electrically connected to the junction box.

6. The solar and fuel powered portable light tower as claimed in claim 5 comprises,
the telescopic arm being pivoted between a down position and an up positioned, wherein the telescopic arm is pivoted around the connecting pin.

7. The solar and fuel powered portable light tower claimed in claim 1 comprises,
the first power source comprises a plurality of batteries, a charge controller, an inverter box, a plurality of photovoltaic panels, and a combiner box;
the plurality of photovoltaic panels being electrically connected to the combiner box;
the combiner box being electrically connected to the charge controller;
the plurality of batteries being electrically connected to the charge controller;
the charge controller being electrically connected to the inverter box; and
the inverter box being electrically connected to the first switch.

8. The solar and fuel powered portable light tower as claimed in claim 7 comprises,
the plurality of photovoltaic panels comprises a connecting frame;
the connecting frame being attached to the top surface from above;
the plurality of photovoltaic panels being adjacently connected to the connecting frame; and
the combiner box being positioned within the connecting frame.

9. The solar and fuel powered portable light tower as claimed in claim 7 comprises,
the plurality of batteries being positioned in the first enclosure and connected to the bottom surface; and
the charge controller and the inverter box being positioned above the plurality of batteries and connected to the portable base.

10. The solar and fuel powered portable light tower as claimed in claim 1 comprises,
the second power source being electrically connected to the second switch, wherein the second power source is a fuel powered generator.

11. The solar and fuel powered portable light tower as claimed in claim 1 comprises,
the control panel being positioned within the portable base;
the junction box being positioned adjacent to the control panel;
the first switch and the second switch being positioned on the control panel;
the first switch and the second switch being electrically connected to the junction box;
the battery monitoring unit being displayed through the control panel; and
the battery monitoring unit being electrically connected with the charge controller.

12. A solar and fuel powered portable light tower comprises,
a portable base;
a light panel arm;
a first power source;
a second power source;
a control panel;
the portable base comprises a top surface, a first surface, a second surface, an insulated wall, a first enclosure, a second enclosure, and a bottom surface;
the light panel arm being positioned on the top surface;
the first power source being positioned inside the first enclosure;
the second power source being positioned inside the second enclosure; and
the control panel comprises a junction box, a first switch, a second switch, and a battery monitoring unit.

13. The solar and fuel powered portable light tower as claimed in claim 12 comprises,
the top surface being perpendicularly connected to the first surface and the second surface;
the bottom surface being perpendicularly connected to the first surface and the second surface and positioned oppositely from the top surface;
the insulated wall being centrally positioned between the first surface and the second surface within the top surface and the bottom surface;
the first enclosure being positioned between the first surface and the insulated wall;
the second enclosure being positioned between the second surface and the insulated wall;
the first surface comprises a hitch connector and a connector jack;
the hitch connector being centrally connected onto the first surface from below;
the connector jack being connected to the hitch connector;
the second surface comprises a pair of supporting jacks;
the pair of jacks being positioned oppositely from each other and connected onto the second surface from below;
the bottom surface comprises a pair of wheels and an axle;
the axle being traversed through the bottom surface; and
the pair of wheels being connected to the axle from each end.

14. The solar and fuel powered portable light tower as claimed in claim 12 comprises,
the light panel arm comprises a telescopic arm, a vertical arm, a connecting pin, and a plurality of light panels;
the telescopic arm comprises a first extension arm and a second extension arm;
the vertical arm being positioned between the telescopic arm and the top surface and connected to the top surface;
the first extension arm and the second extension arm being horizontally extended out from the telescopic arm;
the telescopic arm being connected to the vertical arm by the connecting pin;
the plurality of light panels being adjacently positioned on the first extended arms and the second extension arm;
the plurality of light panels being electrically connected to the junction box; and
the telescopic arm being pivoted between a down position and an up positioned, wherein the telescopic arm is pivoted around the connecting pin.

15. The solar and fuel powered portable light tower claimed in claim 12 comprises,
the first power source comprises a plurality of batteries, a charge controller, an inverter box, a plurality of photovoltaic panels, and a combiner box;
the plurality of photovoltaic panels being electrically connected to the combiner box;
the combiner box being electrically connected to the charge controller;
the plurality of batteries being electrically connected to the charge controller;
the charge controller being electrically connected to the inverter box;
the inverter box being electrically connected to the first switch;
the plurality of photovoltaic panels comprises a connecting frame;
the connecting frame being attached to the top surface from above;
the plurality of photovoltaic panels being adjacently connected to the connecting frame;
the combiner box being positioned within the connecting frame;
the plurality of batteries being positioned in the first enclosure and connected to the bottom surface;
the charge controller and the inverter box being positioned above the plurality of batteries and connected to the portable base; and
the second power source being electrically connected to the second switch, wherein the second power source is a fuel powered generator.

16. The solar and fuel powered portable light tower as claimed in claim 12 comprises,
the control panel being positioned within the portable base;
the junction box being positioned adjacent to the control panel;
the first switch and the second switch being positioned on the control panel;
the first switch and the second switch being electrically connected to the junction box;
the battery monitoring unit being displayed through the control panel; and
the battery monitoring unit being electrically connected with the charge controller.

17. A solar and fuel powered portable light tower comprises,
a portable base;
a light panel arm;
a first power source;
a second power source;
a control panel;
the portable base comprises a top surface, a first surface, a second surface, an insulated wall, a first enclosure, a second enclosure, and a bottom surface;
the light panel arm being positioned on the top surface;
the first power source being positioned inside the first enclosure;
the second power source being positioned inside the second enclosure;
the control panel comprises a junction box, a first switch, a second switch, and a battery monitoring unit;
the control panel being positioned within the portable base;
the junction box being positioned adjacent to the control panel;
the first switch and the second switch being positioned on the control panel;
the first switch and the second switch being electrically connected to the junction box;
the battery monitoring unit being displayed through the control panel; and
the battery monitoring unit being electrically connected with the charge controller.

18. The solar and fuel powered portable light tower as claimed in claim 17 comprises,
the top surface being perpendicularly connected to the first surface and the second surface;
the bottom surface being perpendicularly connected to the first surface and the second surface and positioned oppositely from the top surface;
the insulated wall being centrally positioned between the first surface and the second surface within the top surface and the bottom surface;
the first enclosure being positioned between the first surface and the insulated wall;
the second enclosure being positioned between the second surface and the insulated wall;
the first surface comprises a hitch connector and a connector jack;
the hitch connector being centrally connected onto the first surface from below;
the connector jack being connected to the hitch connector;
the second surface comprises a pair of supporting jacks;
the pair of jacks being positioned oppositely from each other and connected onto the second surface from below;
the bottom surface comprises a pair of wheels and an axle;
the axle being traversed through the bottom surface; and
the pair of wheels being connected to the axle from each end.

19. The solar and fuel powered portable light tower as claimed in claim 17 comprises,
the light panel arm comprises a telescopic arm, a vertical arm, a connecting pin, and a plurality of light panels;
the telescopic arm comprises a first extension arm and a second extension arm;
the vertical arm being positioned between the telescopic arm and the top surface and connected to the top surface;
the first extension arm and the second extension arm being horizontally extended out from the telescopic arm;
the telescopic arm being connected to the vertical arm by the connecting pin;
the plurality of light panels being adjacently positioned on the first extended arms and the second extension arm;
the plurality of light panels being electrically connected to the junction box; and
the telescopic arm being pivoted between a down position and an up positioned, wherein the telescopic arm is pivoted around the connecting pin.

20. The solar and fuel powered portable light tower claimed in claim 17 comprises,
the first power source comprises a plurality of batteries, a charge controller, an inverter box, a plurality of photovoltaic panels, and a combiner box;
the plurality of photovoltaic panels being electrically connected to the combiner box;
the combiner box being electrically connected to the charge controller;
the plurality of batteries being electrically connected to the charge controller;
the charge controller being electrically connected to the inverter box;
the inverter box being electrically connected to the first switch;
the plurality of photovoltaic panels comprises a connecting frame;
the connecting frame being attached to the top surface from above;
the plurality of photovoltaic panels being adjacently connected to the connecting frame;
the combiner box being positioned within the connecting frame;
the plurality of batteries being positioned in the first enclosure and connected to the bottom surface;
the charge controller and the inverter box being positioned above the plurality of batteries and connected to the portable base; and
the second power source being electrically connected to the second switch, wherein the second power source is a fuel powered generator.
